(19) United States
(12) Patent Application Publication
(10) Pub. No.: US 2022/0203268 A1
(43) Pub. Date: Jun. 30, 2022

(54) Non-Aqueous Defoamer Compositions and Their Use to Control Foaming of Non-Aqueous Foams

(71) Applicant: Sasol Chemicals GmbH, Hamburg (DE)

(72) Inventors: Ramesh Varadaraj, Houston, TX (US); Ollie James, Westlake, LA (US); Dustin Landry, Westlake, LA (US)

(21) Appl. No.: 17/607,722

(22) PCT Filed: May 1, 2020
(86) PCT No.: PCT/US2020/030936

§ 371 Date: Oct. 29, 2021

Related U.S. Application Data
(60) Provisional application No. 62/842,665, filed on May 3, 2019.

(51) Int. Cl. B01D 19/04; C10G 33/04

(52) U.S. Cl. CPC B01D 19/0404; C10G 33/04

(57) ABSTRACT

The use of a composition for defoaming non-aqueous foams, the prevention of foam formation, and/or the deaeration of various feeds, wherein said nonaqueous foam comprises a non-aqueous phase and a gas, and wherein said composition comprises at least: i) a non-ionic surfactant, wherein said non-ionic surfactant has a molecular structure as shown in (I), R¹—CH(R²)—CH₂—O—(A′O)ₘ(A″O)ₙ—H wherein R¹ is an alkyl group having from 5 to 16 carbon atoms, R² is an alkyl group having from 5 to 16 carbon atoms, A′O is an ethoxy (EO) or a propoxy (PO) group, A″O is an ethoxy (EO) or a propoxy (PO) group, m=0-10, n=20-150, and ii) a solvent.

The present invention relates to defoamer, antifoamer and/or deaeration compositions and the use thereof for the defoaming of non-aqueous foams, the prevention of foam formation and/or the deaeration of feeds. More specifically, the compositions relate to non-ionic surfactants, specifically 2-alkyl-1-alkanol alkoxylates together with a solvent, to be used as additives for foam destruction, foam prevention or deaeration of non-aqueous phases.

### BACKGROUND OF THE INVENTION AND DISCUSSION OF THE PRIOR ART

Refineries and chemical processing plants have had the long standing problem of controlling non-aqueous foams in reactor vessels. These foams are a result of gaseous products that form for instance during processing of feeds such as crude oils in refineries. Illustrative examples of industrial processing units requiring non-aqueous foam control include delayed coker units in refineries, aldehyde recovery units in synthesis gas processing, crude oil/gas separators, and metal working processes requiring non-aqueous lubrication. Current methods to control foam include mechanical means such as use of baffles and mixing control systems. In conjunction, chemical defoamers or antifoamers are often used. Well known antifoamers include silicone oils, linseed oil, as well as block copolymers of lower alkylene glycols. The most widely used defoamers comprise poly dimethyl siloxane (PDMS). PDMS is used “as is” or mixed with hydrophobic silica to form non-aqueous defoamer compositions, as described for example in BASF's EP1025757B1. The main drawback associated with the use of PDMS is the introduction of silicon into the hydrocarbon product. This is undesirable as silicon can poison refining catalysts such as hydrotreating and desulfurization catalysts. Some non-silicon defoamers have been proposed in the prior art, such as high molecular polypropoxylates or butyl, nonyl-phenol based block polyalkoxylates (US2006/0025324), but there is an ongoing need and search for simple, low concentration and low cost non-silicon based, non-aqueous defoamers, antifoamers and/or deaerators for application in the chemical and industrial process industry.

Useful application areas include, but is not limited to, technology areas such as oil and gas, agrochemical, fermentation, water treatments, pulp and paper, metalworking fluids, paints and coatings, emulsion polymerization and construction. All prior art patents, patent publications, and non-patent literature listed herein are incorporated herein by reference for all purposes.

### OBJECT OF THE PRESENT INVENTION

The advantage of the inventive compositions and their use as described is the provision of novel, non-silicon based compositions for the effective defoaming, antifoaming and deaeration of various non-aqueous feeds.

### SUMMARY OF THE INVENTION

The present invention relates to a range of 2-alkyl-1-alkanol alkoxylates (or so-called Guerbet-alcohol derived alkoxylates) that, together with the use of a solvent, are effective as antifoamers, defoamers and deaerators of non-aqueous phases.

The present invention teaches the use of compositions for defoaming non-aqueous foams, the prevention of foam formation and/or the deaeration of various feeds, wherein said non-aqueous foam comprises a non-aqueous phase and a gas, and wherein said composition comprises at least:
i) a non-ionic surfactant, wherein said non-ionic surfactant has a molecular structure as shown in [I]:

R¹—CH(R²)—CH₂—O—(A′O)ₘ(A″O)ₙ—H [I]
wherein
R¹ is a linear or branched alkyl group having from 5 to 16 carbon atoms, preferably from 9 to 16 carbon atoms,
R² is a linear or branched alkyl group having from 5 to 16 carbon atoms, preferably from 9 to 16 carbon atoms,
A′O is an ethoxy (EO) or a propoxy (PO) group,
A″O is an ethoxy (EO) or a propoxy (PO) group,
m=0−10,
n=20-150, preferably 20-50, and
ii) a solvent.

The use of the composition is also specifically described wherein m=0 and A″O is an ethoxy (EO) group.

The non-ionic surfactant preferably increases the interfacial tension (IFT) between the non-aqueous phase and the gas by at least 1 mN/m at temperatures from 20° C. to about 350° C. The non-ionic surfactant is preferably stable up to 350° C.

In one embodiment of the invention, approximately 0.01-10 wt % of the non-ionic surfactant is insoluble in the non-aqueous phase of the foam.

The solvent preferably comprises a compound or mixture of compounds selected from the group of toluene, xylene, hexane, heptane, octane, nonane, decane, undecane, dodecane, diesel, ethanol, propanol, butanol, and pentanol.

Without limiting the scope of the invention, the non-aqueous foam comprises a gas, wherein the gas could be methane, ethane, propane, butane, pentane, air, nitrogen, carbon dioxide, carbon monoxide, hydrogen sulphide, hydrogen, argon or mixtures thereof.

In addition, the non-aqueous phase preferably comprises diesel, including Fischer-Tropsch derived diesel, crude oil or crude oil distillates, with carbon numbers ranging from 12 to 50, or mixtures thereof.

In one embodiment of the invention, the composition could further comprise solids, preferably ranging from 0.5 micron to 100 micron in size. The solids could be selected from silica, clay or mixtures thereof.

In a further embodiment of the invention, the non-ionic surfactant is stable from 20° C. to at least 350° C.

The use of the composition is also described wherein the addition of the non-ionic surfactant leads to an increase in effective foam reduction of between 50 and 100%, preferably of between 60 and 100%, most preferably of between 70 and 100%. The effectiveness of the non-ionic surfactant is calculated as a percentage of the time measured for foam collapse when the non-ionic surfactant was added to the non-aqueous phase, relative to the time for foam collapse when no non-ionic surfactant was added to the non-aqueous phase.

The method according to the invention involves the defoaming a non-aqueous foam, where the non-aqueous foam comprises a non-aqueous phase and a gas, wherein the method comprises:

providing a composition comprising at least:
i) a non-ionic surfactant, wherein said non-ionic surfactant has a molecular structure as shown in [I]:

R¹—CH(R²)—CH₂—O—(A′O)ₘ(A″O)ₙ—H [I]

wherein R¹ is a linear or branched alkyl group having from 5 to 16 carbon atoms, preferably from 9 to 16 carbon atoms,

R² is a linear or branched alkyl group having from 5 to 16 carbon atoms, preferably from 9 to 16 carbon atoms,

A′O is an ethoxy (EO) or a propoxy (PO) group,

A″O is an ethoxy (EO) or a propoxy (PO) group,

m=0-10,

n=20-150, preferably 20-50,
ii) a solvent; and contacting said non-aqueous foam with said composition whereby said nonaqueous foam breaks.

The method of the invention further involves preventing foaming in a non-aqueous material or deaerating a nonaqueous material, said method comprising: providing a composition comprising at least:
i) a non-ionic surfactant, wherein said non-ionic surfactant has a molecular structure as shown in [I]:

R¹—CH(R²)—CH₂—O—(A′O)ₘ(A″O)ₙ—H [I]

wherein R¹ is a linear or branched alkyl group having from 5 to 16 carbon atoms, preferably from 9 to 16 carbon atoms,

R² is a linear or branched alkyl group having from 5 to 16 carbon atoms, preferably from 9 to 16 carbon atoms,

A′O is an ethoxy (EO) or a propoxy (PO) group,

A″O is an ethoxy (EO) or a propoxy (PO) group,

m=0-10,

n=20-150, preferably 20-50, and
ii) a solvent; and

contacting said non-aqueous material with said composition whereby (a) foam is prevented from forming in said non-aqueous material, (b) said non-aqueous material is deaerated, or both (a) and (b).

### BRIEF DESCRIPTION OF THE DRAWINGS

FIG. 1 shows the thermogravimetric data for alcohol ethoxylated ISOFOL 2426S-50EO.

FIG. 2 shows the thermogravimetric data for alcohol ethoxylated ISOFOL 32-54 EO.

FIG. 3 shows the dynamic interfacial tension vs. bubble frequency for ISOFOL 2426S-50EO and PDMS.

FIG. 4 shows the influence of hydrocarbon chain structure on performance.

FIG. 5 shows the influence of the number of EO groups on performance.

FIG. 6 shows the influence of end capping the EO group with one PO group.

FIG. 7 shows the effect of defoamer concentration on performance.

FIG. 8 shows the influence of 2-alkyl-1-alkanol ethoxylate molecular structure.

FIG. 9 shows a comparison of 2-alkyl-1-alkanol ethoxylate with PDMS and PPG polymers.

FIG. 10 shows a comparison of 2-alkyl-1-alkanol ethoxylate with commercial defoamers.

FIG. 11 shows the influence of temperature on performance.

FIG. 12 shows a time lapse of defoaming.

### DETAILED DESCRIPTION OF PREFERRED EMBODIMENTS

The surfactant compositions of the present invention are effective defoamers, antifoamers and deaerators for a wide variety of non-aqueous phases. The performance of the compositions can be optimally designed by tailoring the hydrophobe structures of the compounds, together with the number of EO units, for a specific application area.

Materials

A number of surfactants, namely ethoxylated alcohols, were synthesized by reacting an alcohol with ethylene oxide in the presence of a suitable catalyst. Such procedures are well known to those skilled in the art. In the examples below (and in preferred embodiments), the surfactants were prepared using the methods and catalysts described in U.S. Pat. No. 8,329,609. Other well-known catalysts such as KOH or double metal cyanide (DMC) are also suitable for preparing the surfactants of the present invention. The compounds are described in Table 1:

TABLE 1
Structure of ethoxylated alcohols

| | Alcohol | | Number of |
|---|---|---|---|
| | carbon | | ethylene |
| Alcohol | chain | | oxide |
| Trade Name | length | Alcohol structure | units (EO) |
| ISOFOL2426S | C24-26 | 100% 2-alkyl branched | 150 |
| | | 2.16 branches per molecule | |
| ISOFOL2426S | C24-26 | 100% 2-alkyl branched | 100 |
| | | 2.16 branches per molecule | |
| ISOFOL2426S | C24-26 | 100% 2-alkyl branched | 50 |
| | | 2.16 branches per molecule | |
| ISOFOL2426S | C24-26 | 100% 2-alkyl branched | 20 |
| | | 2.16 branches per molecule | |
| ISOFOL12 | C12 | 100% 2-alkyl branched | 50 |
| | | 1.0 branches per molecule | |
| ISOFOL16 | C16 | 100% 2-alkyl branched | 50 |
| | | 1.0 branches per molecule | |
| ISOFOL20 | C20 | 100% 2-alkyl branched | 150 |
| | | 1.0 branches per molecule | |
| ISOFOL20 | C20 | 100% 2-alkyl branched | 100 |
| | | 1.0 branches per molecule | |
| ISOFOL20 | C20 | 100% 2-alkyl branched | 50 |
| | | 1.0 branches per molecule | |
| ISOFOL20 | C20 | 100% 2-alkyl branched | 20 |
| | | 1.0 branches per molecule | |
| ISOFOL24 | C24 | 100% 2-alkyl branched | 50 |
| | | 1.0 branches per molecule | |
| ISOFOL32 | C32 | 100% 2-alkyl branched | 54 |
| | | 1.0 branches per molecule | |
| MARLIPAL | C13 | Branched | 50 |
| TDA | | 2.30 branches per molecule | |
| (isotridecanol) | | | |
| ALFOL12 | C12 | linear | 50 |
| ALFOL C20+ | C20+ | linear | 50 |

The amount of branching was determined by proton nuclear magnetic resonance (NMR). All examples represented by trade names above are marketed by Sasol Performance Chemicals.

Table 2 shows the commercial prior art defoamers that were used for comparative experiments.

TABLE 2
Defoamers from the prior art used for comparative examples

| Name | Description |
|---|---|
| PDMS-2500 | Polydimethyl siloxane mol wt = |
| | 2500, viscosity = 20,000 cP |
| (C-2785)* | Polydimethyl siloxane defoamer formulation |
| PEG-50EO | Polyethylene glycol - 50EO |
| PPG-900 | Polypropylene glycol mol wt = 900 |
| (C-2398)* | Polypropylene defoamer formulation |
| (C-2280)* | Polypropylene defoamer formulation |

*Sold by New London Chemicals, Inc. Florida, USA

Experimental Section

Experiment 1: Thermal Stability

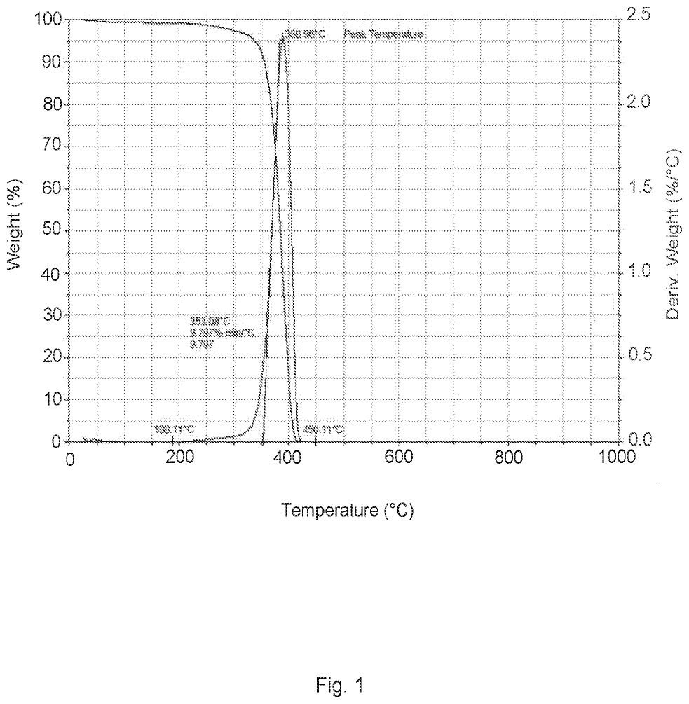

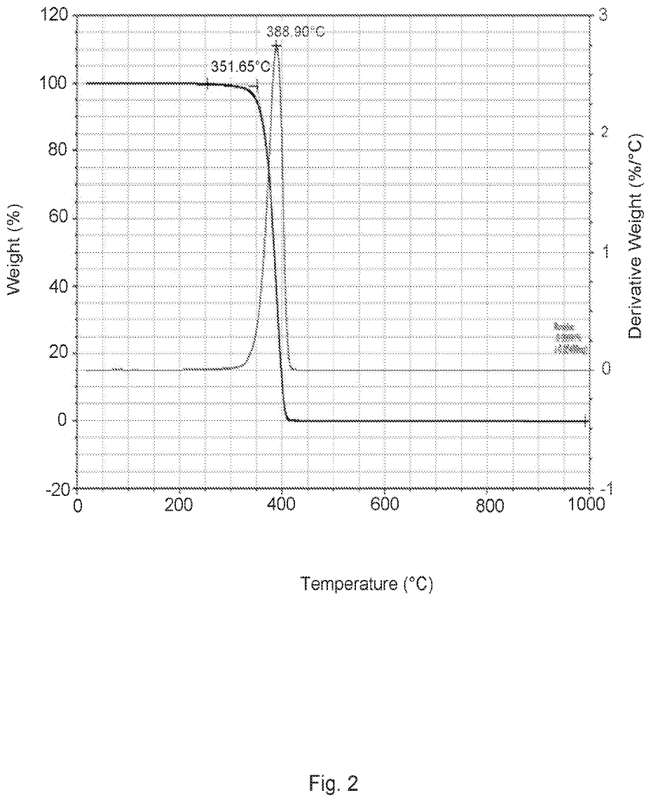

Thermogravimetric analysis (TGA) measurements were made using a TGA Q 500 TA instrument. About 30 mg of sample was heated in a N₂ atmosphere at a rate of 9.8° C./min. Thermogravimetric data for two representative alcohol ethoxylates, namely ISOFOL 2426S-50 EO and ISOFOL 32-54EO are shown FIGS. 1 and 2.

As can be observed, the ISOFOL 2426-50 EO alcohol ethoxylate is thermally stable up to 354° C., and the ISOFOL 32-54 EO alcohol ethoxylate is thermally stable up to 351° C. These temperatures define the thermal window for specifically the use of the 2-alkyl branched alcohol high mole ethoxylates.

Experiment 2: Gas/Non-Aqueous Phase Interfacial Tension

Experimental Procedure:

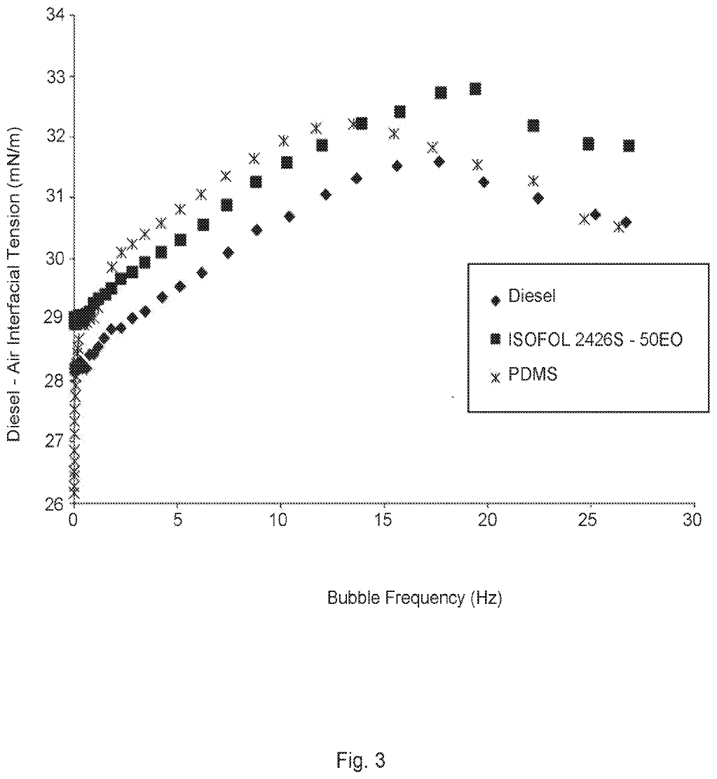

Dynamic interfacial tension (IFT) measurements were made using a Kruss BP-100 bubble pressure tensiometer. Diesel was used as the non-aqueous phase and air was the gas. Air was bubbled through diesel and IFT determined as a function of bubble frequency. A defoamer dispersion at 1 wt % concentration was made in diesel. About 0.6 ml of defoamer dispersion was added to 70 ml of diesel at ambient room temperature and IFT measured as a function of bubble frequency. The defoamers tested were ISOFOL 2426S-50 EO and PDMS (2500 molecular weight sample obtained from Dow Chemicals). Dynamic IFT data is given in FIG. 3.

As can be observed from the IFT data ISOFOL 2426S-50EO increases the IFT of diesel over the range of bubble frequency measured. The ability of the defoamer to increase the IFT of the gas/non-aqueous phase is a key requirement for the non-ionic surfactant to perform as a defoamer. The laboratory data disclosed herein demonstrates this property. Comparative data for PDMS is also shown in FIG. 2. The ability for ISOFOL 2426S-50EO to increase the IFT over the full range of bubble frequency is unique. PDMS also increases the IFT as to be expected. However, we observe ISOFOL 2426S performs better at higher bubble frequency compared to PDMS with respect to IFT increase.

Solubility, thermal stability and IFT results collectively indicate that ISOFOL 2426S-50EO possesses the fundamental properties required to break/destabilize nonaqueous foam. These results can be extrapolated to the 2-alkyl-1-alkanol alkoxylate compounds of the present invention.

Defoamer/Antifoamer Performance Evaluation

Laboratory Performance Evaluation Method

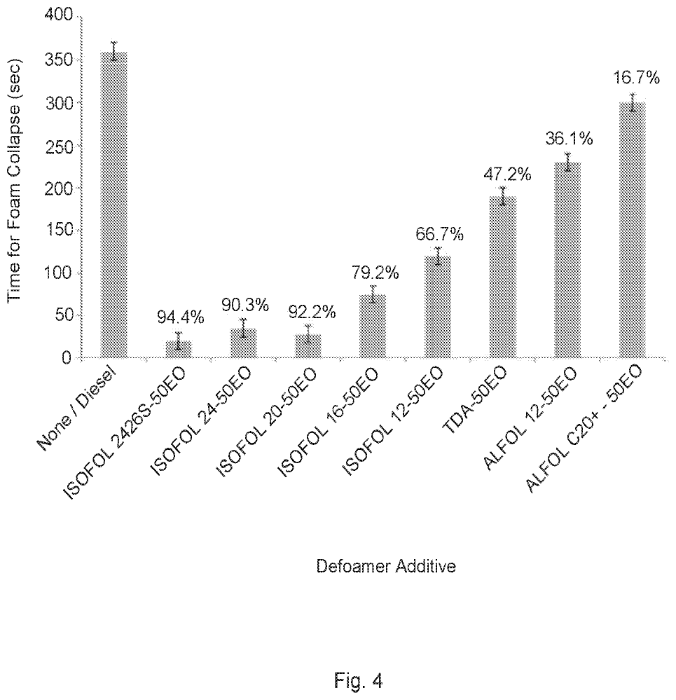

A simple laboratory test was designed to rapidly screen defoamers/antifoamers for non-aqueous defoaming performance at room temperature. The non-aqueous defoamer/antifoamer test procedure comprised the steps of: introducing 10 ml of a non-aqueous liquid (diesel) into a 20 ml glass test tube to create a head space of 8 cc, adding the defoamer/antifoamer additive (at 1 to 10 wt % treat rate) to the non-aqueous liquid, tightly closing the test tube, shaking the test tube by hand for 5 minutes to produce non-aqueous foam, setting the test tube on a lab bench, and taking photographs of the test tube every 15 seconds for about 10 to 15 minutes, or until there is no more foam in the test tube. From the time-lapse photography the time taken for the non-aqueous foam to completely collapse was determined. The pictures were examined to ascertain the nature of foam and coalescence stages. The performance test was conducted at least 5 times and the average foam collapse time determined. The effectiveness of a defoamer additive was calculated as a percentage of the time measured for foam collapse when the defoamer additive was added to the diesel, relative to the time for foam collapse when no additive was added to the diesel. An effective defoamer is characterized by a percentage value of between approximately 50-100%. The effectiveness value is shown as a percentage value at the top of each bar in the bar graphs of the Figures (for example, in the results shown in FIG. 4, TDA-50EO was 47.2% effective while ISOFOL 2426S-50EO was 94.4% effective). This general experimental procedure was used for all the following experiments described, except if specifically noted otherwise.

Experiment 3: Influence of Hydrocarbon Chain Structure (Linearity/Branching/Type of Branching/Length of Carbon Chain)

To determine the influence of the nature of the hydrocarbon chain structure on defoamer/antifoamer performance, a series of 50 mole ethoxylates (1 wt %) of the following alcohols were evaluated using the general Laboratory Performance Evaluation Method described above: ISOFOL 12, ISOFOL 16, ISOFOL 20, ISOFOL 24, ISOFOL 2426S, TDA, ALFOL12, and ALFOL C20+.

Results are shown in FIG. 4.

It was observed that hydrocarbon chain structure influences performance. Specifically, hydrocarbon chain branching improved defoamer/antifoamer performance when compared to linear carbon chain structures. Amongst the branched ISOFOL ethoxylates, increasing the hydrocarbon chain length had a marked influence on performance. A hydrocarbon chain length of 20 carbons or more with a 2-alkyl branching structure resulted in the best performance.

Experiment 4: Influence of Number of EO Groups

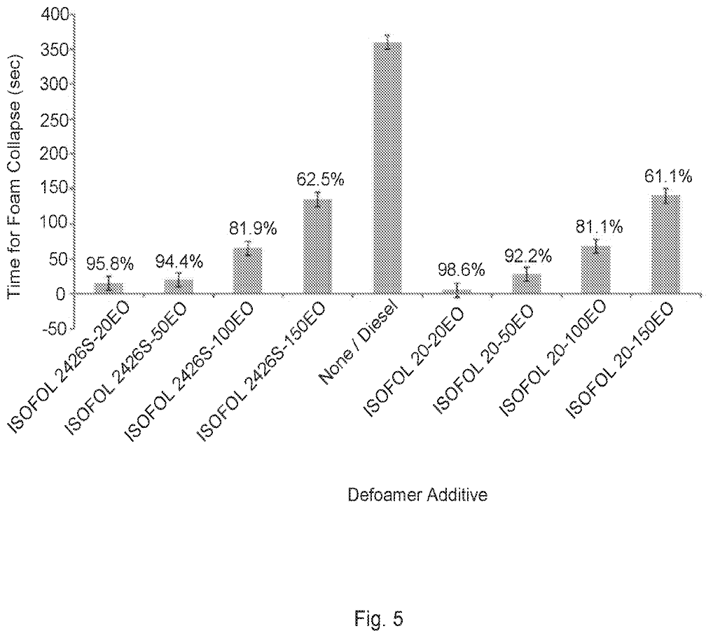

To ascertain the influence of the number of EO groups or degree of ethoxylation on defoamer/antifoamer performance, 20, 50, 100 and 150 mole ethoxylates of ISOFOL 20 and ISOFOL 2426S were tested (1 wt % dosage), using the general Laboratory Performance Evaluation Method. ISOFOL 20 and ISOFOL 2426S were selected based on their superior performance from the earlier experiment. Results are shown in FIG. 5.

Decreasing the number of EO groups from 150 to 20 improved defoamer/antifoamer performance. The optimum number of EO groups was 20 to 50.

Experiment 5: Effect of End Capping EO Group with 1 PO

Using the general Laboratory Performance Evaluation Method, the effect of end capping the ethoxylate with a propoxylate (1 PO) on defoamer/antifoamer performance was tested by synthesizing end capped ISOFOL 2426S50EO with 1 PO and testing the end capped polymer (1 wt % dosage).

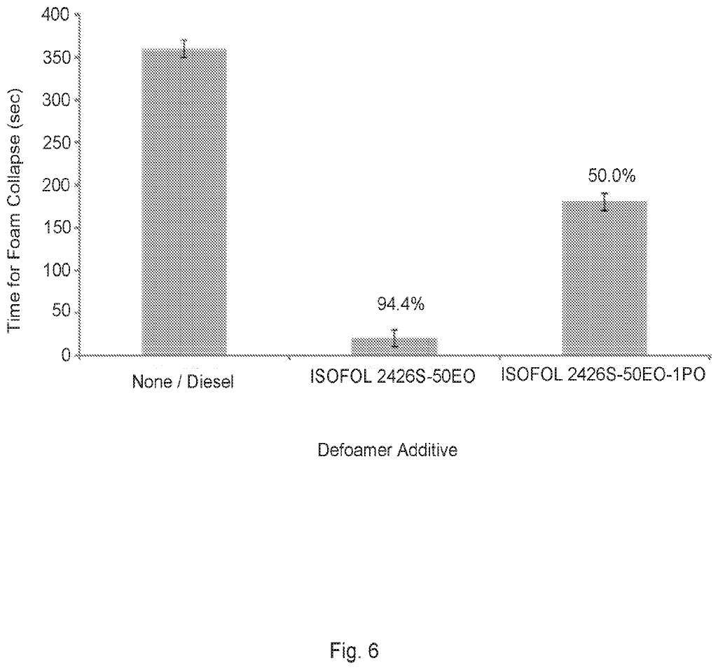

The result shown in FIG. 6 indicated that end capping the ISOFOL 2426S-50EO ethoxylate with 1 PO does not improve performance. On the contrary, the presence of the PO group decreased performance.

Experiment 6: Effect of Concentration

The effect of defoamer/antifoamer concentration on performance was evaluated (using the general Laboratory Performance Evaluation Method) by varying the concentration of ISOFOL 20-20EO from 10 to 1 wt %. Defoamers are used to defoam/break existing foams. They are applied/sprayed directly on the foam and as such the local concentration of the defoamer in the liquid lamellae is high. Antifoamers are used to prevent formation of foam and are added to the non-aqueous liquid in small quantities. Thus, effectiveness at low concentration is indicative of antifoaming performance and while effectiveness at high concentration is indicative of defoamer performance.

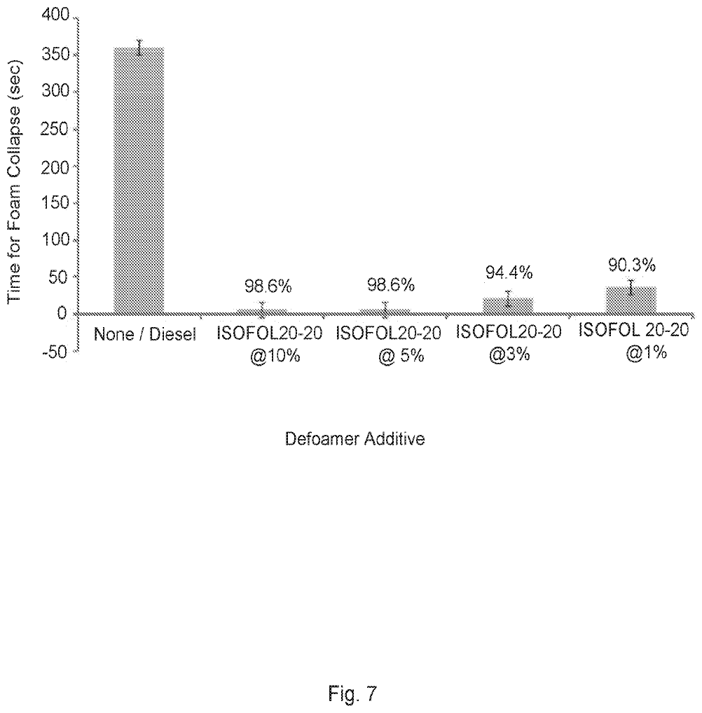

As shown in FIG. 7, ISOFOL 20-20EO was effective over the range of concentrations tested, indicating its suitability as a defoamer or antifoamer.

Experiment 7: Importance of the 2-Alkyl-1-Alkanol (Guerbet) Ethoxylate Molecular Structure Vs the Corresponding Alcohol Structure

In order to determine the importance of a 2-alkyl-alkanol (or so-called Guerbet-alcohol derived) ethoxylate molecular structure on defoamer/antifoamer performance, the performance of ISOFOL 20 alcohol,

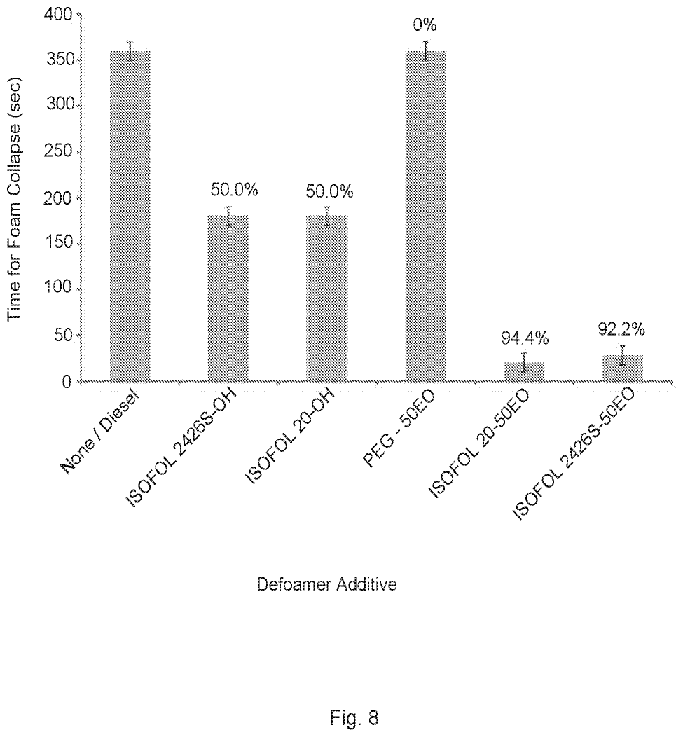

ISOFOL 2426S alcohol and polyethylene (50) glycol were compared to that of ISOFOL 20-50EO and ISOFOL 2426S-50EO in FIG. 8. The general Laboratory Performance Evaluation Method was applied.

Results shown in FIG. 8 clearly demonstrate the importance of a 2-alkyl 1-alkanol ethoxylate molecular structure. Neither the alcohols by themselves nor the PEG-50 were effective as defoamers/antifoamers compared to the corresponding 2-alkyl branched ethoxylated alcohols.

Experiment 8: Comparison of 2-Alkyl-1-Alkanol Ethoxylates with Commercially Available Defoamers

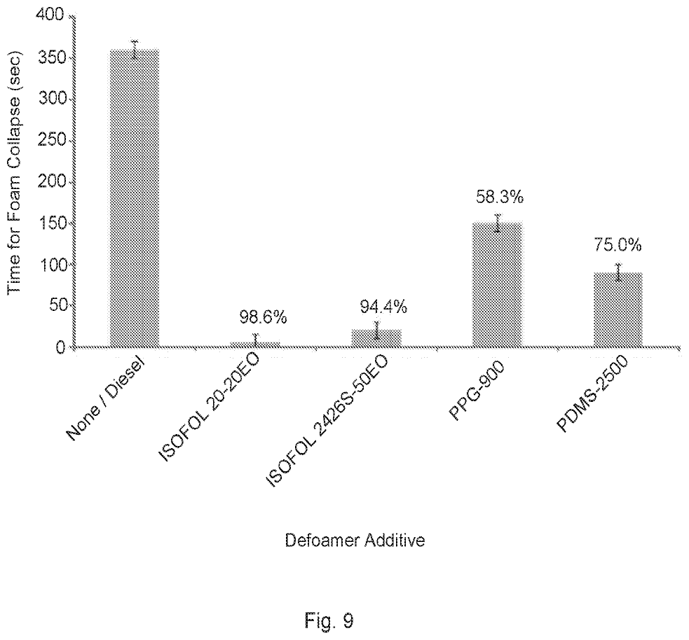

The performance of ISOFOL 20-20EO and ISOFOL 2426S-50EO were compared to commercially available defoamers, PDMS-2500 and PPG-900 (general Laboratory Performance Evaluation Method). Results are shown in FIG. 9.

ISOFOL 20-20EO and ISOFOL 2426S-50EO exhibited better defoamer/antifoamer performance compared to PPG and PDMS of comparable molecular weight. This result demonstrates the effectiveness of the 2-alkyl-1-alkanol ethoxylate over polydimethyl siloxane and polypropylene glycol from a molecular structure fundamentals perspective.

Experiment 9: Comparison of 2-Alkyl-1-Alkanol Ethoxylates with Commercial Defoamer Formulations

The defoamer/antifoamer performances of ISOFOL 20-20EO, ISOFOL 24-50, and ISOFOL 2426S-50EO were compared to commercially available, fully formulated PDMS based (C-2785) and polypropylene based defoamers (C-2398 and C-2280).

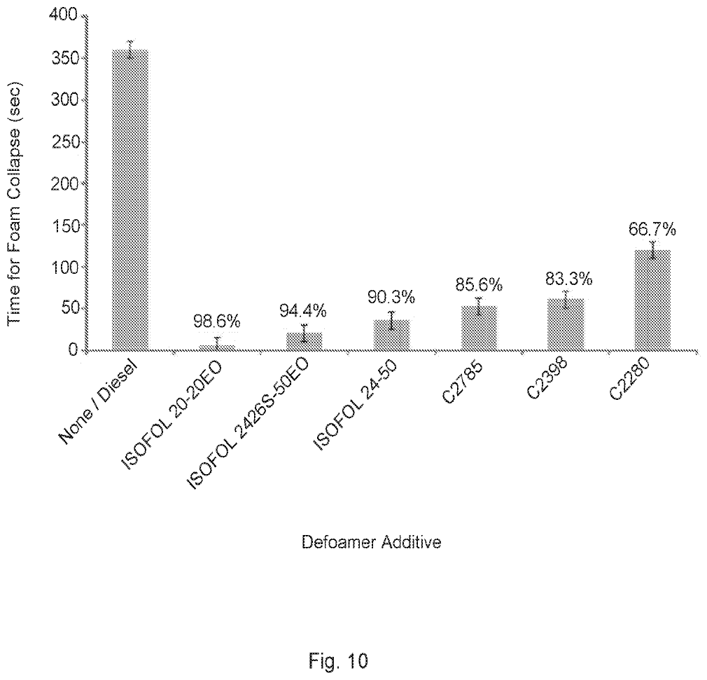

Results obtained by using the general Laboratory Performance Evaluation Method are shown in FIG. 10.

ISOFOL 24-50EO exhibited performance equal to, and ISOFOL 20-20EO & ISOFOL 2426S-50EO exhibited performance better than the commercial defoamers C-2785, C-2398 and C-2280.

Experiment 10: Defoaming Performance of 2-Alkyl-1-Ikanol Alkoxylates at Different Temperatures

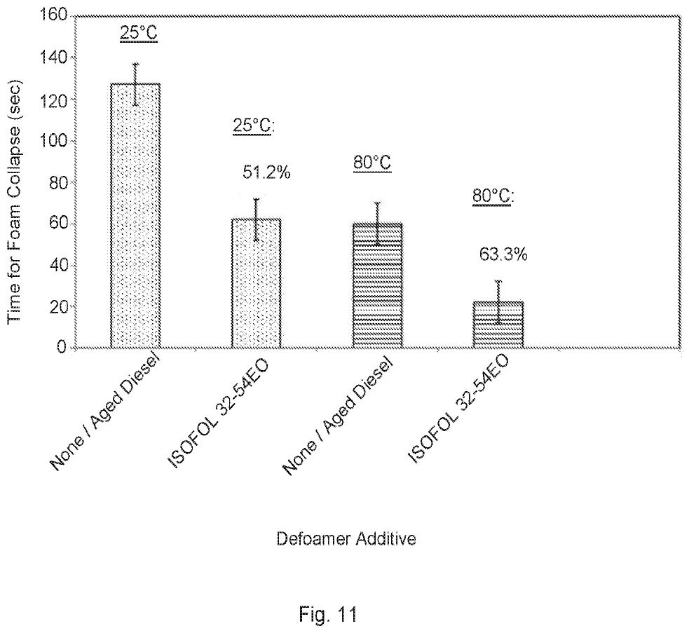

To determine the influence of temperature on defoamer/antifoamer performance, ISOFOL 32-54EO (1 wt %) was evaluated at 25 and 80° C., using the general Laboratory Performance Evaluation Method described earlier. An aged diesel sample was used as non-aqueous liquid. Results are shown in FIG. 11.

It is clear that the ISOFOL 32-54EO exhibited effective defoaming/antifoaming behaviour when added to the non-aqueous liquid, compared to the control experiment where no defoamer was added—both at 25 and 80° C.

Experiment 11: Direct Injection Test: Comparison of 2-Alkyl-1-Alkanol Ethoxylates with Commercial Defoamers

A room temperature direct injection laboratory test was developed to compare the performance of the 2-alkyl-1-alkanol ethoxylates to commercial defoamers. The intent of this direct injection laboratory test was to mimic field process operations wherein defoamers are directly injected on the non-aqueous foam. The test procedure comprised adding diesel to a cylindrical glass jar, closing the jar and vigorously shaking to produce foam. The defoamer was then injected directly on the non-aqueous foam and foam collapse monitored by video recording or time lapse photographs.

Diesel foam was created by vigorously shaking 25 ml of diesel placed in a 100 ml glass jar. Using a syringe, 0.25 ml of defoamer solutions were injected on the foam.

In a comparative experiment the following solutions were tested:
(i) Control: toluene,
(ii) Commercial Defoamer: 1 wt % C2785 in toluene, and
(iii) 1 wt % ISOFOL 2426S-50EO in toluene.

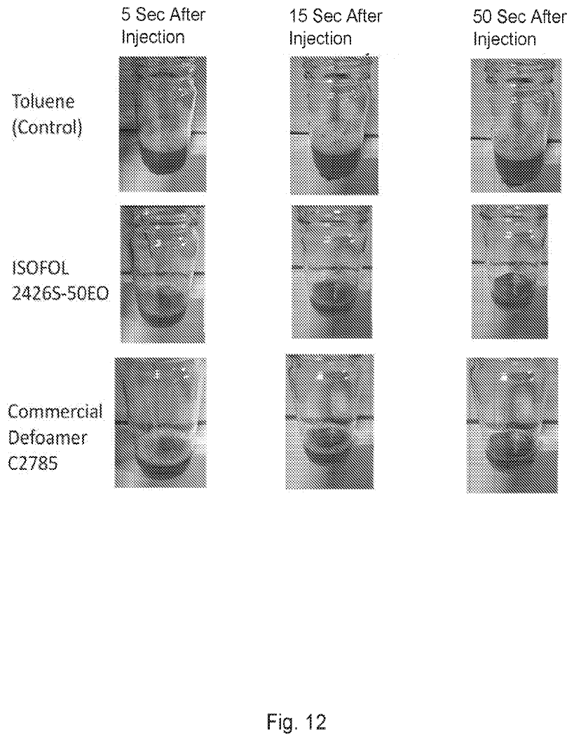

FIG. 12 shows time lapse photographs of the control, ISOFOL 2426S-50EO, and commercial defoamer C2785 respectively after 5, 15 and 50 seconds after injection.

Toluene had no effect on destabilizing the foam. ISOFOL 2426S-50EO was very effective in defoaming the non-aqueous foam. In about 50 seconds after defoamer contact, the foam collapsed completely.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A method of defoaming a non-aqueous foam,
said non-aqueous foam comprising a non-aqueous phase and a gas, said method comprising:
providing a composition comprising at least:
i) a non-ionic surfactant, wherein said non-ionic surfactant has a molecular structure as shown in [I]:
R¹—CH(R²)—CH₂—O—(A′O)ₘ(A″O)ₙ—H [I]
wherein R¹ is a linear or branched alkyl group having from 5 to 16 carbon atoms,
R² is a linear or branched alkyl group having from 5 to 16 carbon atoms,
A′O is an ethoxy (EO) or a propoxy (PO) group,
A″O is an ethoxy (EO) or a propoxy (PO) group,
m=0-10,
n=20-150,
ii) a solvent; and
contacting said non-aqueous foam with said composition whereby said nonaqueous foam breaks.

14. A method of preventing foaming in a non-aqueous material or deaerating a nonaqueous material, said method comprising:
providing a composition comprising at least:
i) a non-ionic surfactant, wherein said non-ionic surfactant has a molecular structure as shown in [I]:
R¹—CH(R²)—CH₂—O—(A′O)ₘ(A″O)ₙ—H [I]
wherein R¹ is a linear or branched alkyl group having from 5 to 16 carbon atoms,
R² is a linear or branched alkyl group having from 5 to 16 carbon atoms,
A′O is an ethoxy (EO) or a propoxy (PO) group,
A″O is an ethoxy (EO) or a propoxy (PO) group,
m=0-10,
n=20-150, and
ii) a solvent; and
contacting said non-aqueous material with said composition whereby (a) foam is prevented from forming in said non-aqueous material, (b) said non-aqueous material is deaerated, or both (a) and (b).

15. The method claim 13 wherein R¹ and/or R² has from 9 to 16 carbon atoms.

16. The method of claim 13 wherein m=0 and A″O is an ethoxy (EO) group.

17. The method of claim 13 wherein n=20 to 50.

18. The method of claim 13 wherein the solvent comprises a selection from the group of toluene, xylene, hexane, heptane, octane, nonane, decane, undecane, dodecane, diesel, ethanol, propanol, butanol, pentanol of mixtures thereof.

19. The method of claim 13 wherein the gas comprises a selection of the group of methane, ethane, propane, butane, pentane, air, nitrogen, carbon dioxide, carbon monoxide, hydrogen sulfide, hydrogen, argon, or mixtures thereof.

20. The method of claim 13 wherein the non-aqueous phase comprises a selection from the group of diesel, including Fischer-Tropsch derived diesel, crude oil or crude oil distillates with carbon numbers from 12 to 50 or mixtures thereof.

21. The method of claim 13 wherein the non-ionic surfactant is thermally stable from 20° C. to at least 350° C.

22. The method of claim 13 wherein the gas/non-aqueous phase interfacial tension is increased by at least 1 mN/m at a temperature from 20° C. to at least 350° C.

23. The method of claim 13 wherein the addition of the non-ionic surfactant leads to an increase in effective foam reduction of between 50 and 100%, the effectiveness of the non-ionic surfactant calculated as a percentage of the time measured for foam collapse when the non-ionic surfactant was added to the non-aqueous phase, relative to the time for foam collapse when no non-ionic surfactant was added to the non-aqueous phase.

24. The method claim 14 wherein R¹ and/or R² has from 9 to 16 carbon atoms.

25. The method of claim 14 wherein m=0 and A″O is an ethoxy (EO) group.

26. The method of claim 14 wherein n=20 to 50.

27. The method of claim 14 wherein the solvent comprises a selection from the group of toluene, xylene, hexane, heptane, octane, nonane, decane, undecane, dodecane, diesel, ethanol, propanol, butanol, pentanol of mixtures thereof.

28. The method of claim 14 wherein the non-aqueous material comprises a selection from the group of diesel, including Fischer-Tropsch derived diesel, crude oil or crude oil distillates with carbon numbers from 12 to 50 or mixtures thereof.

29. The method of claim 14 wherein the non-ionic surfactant is thermally stable from 20° C. to at least 350° C.
